(19) United States
(12) Patent Application Publication
(10) Pub. No.: US 2011/0140406 A1
(43) Pub. Date: Jun. 16, 2011

(54) TRACE BINDING

(76) Inventors: Joseph Paul Soares, Hope Valley, RI (US); Janice Mae Soares, Hope Valley, RI (US)

(21) Appl. No.: 12/951,619

(22) Filed: Nov. 22, 2010

Related U.S. Application Data
(60) Provisional application No. 61/286,656, filed on Dec. 15, 2009.

(51) Int. Cl. B42D 1/00; B41F 33/00

(52) U.S. Cl. 281/21.1; 101/483; 281/15.1

(57) ABSTRACT

A method for producing a printed publication may comprise selecting an object associated with a topic of the printed publication, refining the object, and incorporating the refined object as a physical part of the printed publication. By incorporating the object as a physical part of the printed publication, a reader of the printed publication may form a stronger connection to the topic or subject matter of the printed publication, thereby strengthening retention of and interest in the subject matter of the printed publication.

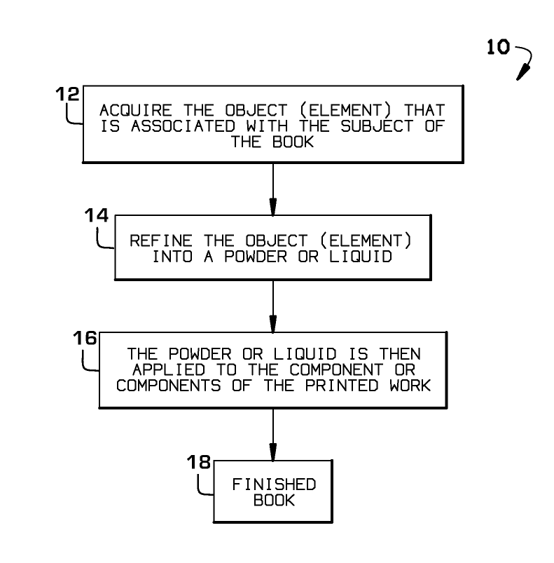

### CROSS-REFERENCE TO RELATED APPLICATIONS

This application claims the benefit of priority to U.S. provisional patent application No. 61/286,656 filed Dec. 15, 2009, and incorporated herein by reference.

### BACKGROUND OF THE INVENTION

The present invention generally relates to the field of publishing, and more specifically relates to including a physical substance associated with a publication's topic as a part of the printed publication.

### SUMMARY OF THE INVENTION

In one aspect of the present invention, a method for producing a printed publication comprises selecting an object associated with a topic of the printed publication; refining the object; and incorporating the refined object as a physical part of the printed publication.

In another aspect of the present invention, a printed publication comprises an object incorporated within a physical part of the printed publication that is associated with a topic of the printed publication.

These and other features, aspects and advantages of the present invention will become better understood with reference to the following drawings, description and claims.

### BRIEF DESCRIPTION OF THE DRAWINGS

The FIGURE shows a flowchart of a method for incorporating a physical substance related to a topic or subject of a publication within the printed publication in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provides a method for associating a publication's topic or subject matter with the publication by incorporating trace amounts of a physical substance associated with the publication's topic into the physical printed publication.

By incorporating the physical substance into the printed publication, the printed publication may be able to provide to the reader a stronger connection to the topic or subject matter of the printed publication, thereby strengthening retention of and interest in the subject matter of the publication.

Referring now to the FIGURE, a flowchart 10 shows a method for incorporating a physical substance related to a topic or subject of a publication within the printed publication.

At 12, an object that may be directly or indirectly associated or related with a subject matter, topic, plot, storyline, narrative, or account of a printed publication may be obtained. For example, a tree bark may be chosen as the physical object that is incorporated into a book about trees, honey may be chosen as the physical object that is incorporated into a book about honeybees, or DNA samples may be chosen as the physical object that is incorporated into a science textbook.

The object may be in solid or liquid form, and may include, for example, plants, chemicals, DNA samples, and any other object that may be directly or indirectly associated or related with the subject matter. The printed publication may, for example, be a book, magazine, pamphlet, brochure, leaflet, log, manuscript, or any other document, and the printed publication may, for example, contain a novel, fairytale, chronicle, folktale, legend, or any other content.

At 14, the object chosen to be included as a physical part of the printed publication may be refined into a powder or liquid form to make it easier for the object to be physically incorporated as a part of the physical printed publication.

At 16, the powdered or liquid form of the object may be applied to a component of the printed publication. For example, the powdered or liquid form of the object may be incorporated directly into the glue, binding, ink, paper, jacket, or coating making up the physical form of the printed publication. Alternatively, the powered or liquid form of the object may be sprayed upon or otherwise applied directly to pages or coverings of the printed publication.

The amount of object that is mixed into the physical components of the book may depend upon the type of object as well as the characteristics physical components. Generally, the amount of object mixed in should be such that the object does not interfere with the performance of the physical components. For example, if the object is to be mixed into glue, the amount of object that is mixed into the glue should be such that the glue continues to be able to adhere pages of the printed publication together with the binding.

At 18, the method for incorporating a physical substance may be completed by printing and binding the printed publication. Thus, a printed publication having an object incorporated into it associated with a topic of that printed publication may be produced.

Once incorporated into the physical printed publication, the object may give out visual or aromatic reminds of the subject of the printed publication to the reader, thereby strengthening retention or understanding of the subject matter.

In one exemplary embodiment, a brick from the Nichols and Langworthy Machine Company may be obtained, refined into a powder, and added to the glue binding the pages of a book about the Nichols and

Langworthy Machine Company. By adding this physical link to the book, the reader of the book may be provided with a sense of connection to the Nichols and Langworthy Machine Company.

It should be understood, of course, that the foregoing relates to exemplary embodiments of the invention and that modifications may be made without departing from the spirit and scope of the invention as set forth in the following claims.

We claim:

1. A method for producing a printed publication, comprising:
selecting an object associated with a topic of the printed publication;
refining the object; and
incorporating the refined object as a physical part of the printed publication.

2. The method of claim 1, wherein the object is of a solid form.

3. The method of claim 2, wherein the refining comprises refining the solid into a powder.

4. The method of claim 1, wherein the refining comprises refining the object into liquid form.

5. The method of claim 1, wherein the incorporating comprises incorporating the refined object with a binding component of the printed publication.

6. The method of claim 1, wherein the incorporating comprises spraying the refined object onto the printed publication.

7. The method of claim 1, wherein the refined object produces an aroma associated with the topic of the printed publication.

8. A printed publication comprising:
an object incorporated within a physical part of the printed publication that is associated with a topic of the printed publication;
wherein the object is refined into a powder or a liquid.

9. The printed publication of claim 8, wherein the physical part of the printed publication comprises a surface of one or more pages.

10. The printed publication of claim 9, wherein the physical part of the printed publication comprises a binding component.
